(19) United States
(12) Patent Application Publication
(10) Pub. No.: US 2018/0270631 A1
(43) Pub. Date: Sep. 20, 2018

(54) Object Identification Detection System

(71) Applicant: Walmart Apollo, LLC, Bentonville, AR (US)

(72) Inventors: Donald High, Noel, MO (US); John Jeremiah O'Brien, Farmington, AR (US)

(21) Appl. No.: 15/922,090

(22) Filed: Mar. 15, 2018

Related U.S. Application Data
(60) Provisional application No. 62/472,258, filed on Mar. 16, 2017.

(51) Int. Cl. H04W 4/35; G01G 19/415; G01G 19/387; G06K 7/10

(52) U.S. Cl. CPC H04W 4/35; G06K 7/10405; G01G 19/387; G01G 19/415

(57) ABSTRACT

Described in detail herein are systems and methods for an object location detection system. A grid of sensors can receive physical objects on a support surface. The grid of sensors can detect weights of the physical objects. RFID readers can read RFID tags disposed on the plurality of physical objects to discover identifiers associated with the physical objects. A controller can receive out outputs from the sensors and the RFID readers. The controller can ascertain weight locations at which the physical objects are disposed based on the which of the sensor detected the weights. The computing system can associate each one of the weights with a respective one of the identities based on the weight locations at which the physical objects are disposed. The computing system can autonomously trigger an action associated with at least one of the physical objects.

### CROSS-REFERENCE TO RELATED PATENT APPLICATIONS

This application claims priority to U.S. Provisional Application No. 62/472,258 filed on Mar. 16, 2017, the content of which is hereby incorporated by reference in its entirety.

### BACKGROUND

Different physical objects may be consumed at various rates. Replenishment of a physical object can be a slow and error prone process without knowing a consumption rate of a physical object.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a schematic diagram of an exemplary grid of sensors and readers disposed on mats according to an exemplary embodiment;

FIG. 2 illustrates an exemplary object location detection system in accordance with an exemplary embodiment;

FIG. 3 illustrates an exemplary computing device in accordance with an exemplary embodiment;

FIG. 4 is a flowchart illustrating a process of the object location detection system according to an exemplary embodiment; and

FIG. 5 is a flowchart illustrating an exemplary process performed by the object location system according to an exemplary embodiment.

### DETAILED DESCRIPTION

Described in detail herein are systems and methods for an object location detection system. A grid/array of sensors can receive physical objects on a support surface. The grid of sensors can detect weights of the physical objects. RFID readers can read RFID tags disposed on the physical objects to discover identifiers associated with the physical objects. A controller can receive outputs from the sensors and the RFID readers. The controller can ascertain weight locations at which the physical objects are disposed based on the which of the sensor detect the weights. The controller can generating one or more messages that includes the weight locations at which the physical objects are disposed, the weights of physical objects at the weight locations, and the identifiers associated with the physical objects. A computing system can receive the one or more messages from the controller, identify identities of the physical objects based on the identifiers, and associate each one of the weights with a respective one of the identities based on the weight locations at which the physical objects are disposed. The computing system can autonomously trigger an action associated with at least one of the physical objects.

The RFID readers can measure signal power from each of the RFID tags read by the RFID readers and the controller can be configured to determine RFID locations at which the RFID tags are disposed based on the signal power and mapping the RFID locations at which the RFID tags are disposed to the weight locations at which the physical objects are disposed. Each one of the weights is associated with the respective one of the identities based on the weight locations at which the physical objects are disposed and the RFID locations at which the RFID tags are disposed. The controller is configured to assign each one of the weights to the respective one of identities of the physical objects based on matching the weight locations to the RFID locations.

The computing system includes a database and is programmed to query the database to retrieve information associated with the at least one physical object, determine a rate of consumption of the at least one of the physical objects based on the retrieved information and a current weight of the at least one of the physical objects. The information can include one or more of: a weight of the at least one of the physical objects when completely full, an average amount of the at least one of the physical objects consumed/used at one time, an amount of time required to replenish the at least one of the physical objects, an amount of time the at least one of the physical objects has been associated with the grid of sensors or the RFID readers.

The system can include one or more image capturing devices disposed with respect to the physical objects and grid/array of sensors. The image capturing device(s) can be operatively coupled to the controller and can be configured to capture images of the physical objects. The captured images can be transmitted to the controller in response to detecting motion of one or more of the physical objects or in response to a period of time elapsing since a last image capture. The computing system can be programmed to receive the images from the controller, extract attributes associated with each physical objects captured in the images and determine at least one of an amount remaining for each of the physical objects captured in the images based on the attributes, an object location for each of the physical objects captured in the images, or an identity for each of the physical objects captured in the images.

The grid of sensors can disposed across a first layer of a mat, and the RFID readers or antennas of the RFID readers can be disposed across a second layer of the mat. The physical objects can be supported by the mat. In response to a first physical object being removed from a first location on top of the mat, the sensors associated with the first location can output a first change in weight, and the controller can determine that the first object has been removed from the mat. In response to the first physical object being placed at the first location again or at a second location on top of the mat, the sensors at the first or second locations can output a second change in weight that is equal to or less than the first change in weight, and the controller can determine that the first physical object was returned to the first location or the second location. A difference between the first and second change in weight is transmitted to the computing system to be stored in a database. The difference indicates an amount of the first physical object that was consumed/used after being removed from the first location on the mat and being placed on the first or second location of the mat.

When the first physical object is returned to the second location, a first RFID reader (or associated antenna) is disposed within a specified distance of the first location, and a second RFID reader (or associated antenna) is disposed within a specified distance of the second location. The computing system is further programmed to determine the first physical object has been moved from the first location to the second location on top of mat based on a strength of signal detected by the second RFID reader from a first one of the RFID tags disposed on the first physical object.

In response to a first physical object being removed from a first location on top of the mat, the sensors associated with the first location output a first change in weight, the RFID readers fail to read a first one of the RFID tags affixed to the first physical object, and the controller determines that the first object has been removed from the mat based on the first change in weight and the failure to read the first one of the RFID tags. In response to the first physical object being placed at the first location again or at a second location on top of the mat, the sensors at the first or second locations output a second change in weight that is equal to or less than the first change in weight, at least some of the RFID readers read the first one of the RFID tags, and the controller can determine that the first physical object was returned to the first location or the second location based on the second change in weight and reading of the first one of the RFID tags again. If the controller determines that the first one of the physical objects is replaced at the second location, and the controller can transmit a new message to the computing system indicating that the first physical object has been moved from the first location to the second location, and the computing system can update a map of physical object locations based on the new message.

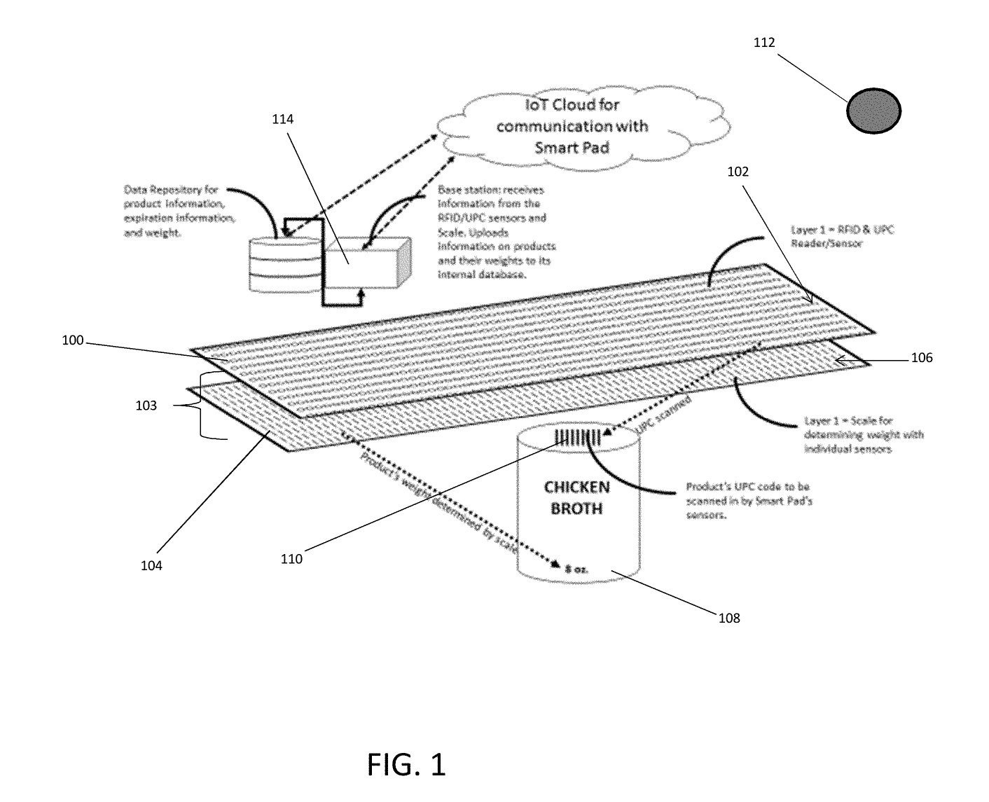

FIG. 1 is a schematic diagram of an exemplary grid/array of sensors and readers disposed on mats according to an exemplary embodiment. In exemplary embodiment, a first layer 100 of a mat 103 can contain a grid of RFID readers or associated antennas 102 and a second layer 104 of the mat 103 can contain a grid/array of weight sensors 106. The grid of RFID readers or associated antennas 102 and the grid of weight sensors 106 can be disposed throughout the first and second layers 100 and 104 of the mat 103, respectively. The grid of RFID readers or associated antennas 102 can include multiple different RFID readers 102 within one or more antennas or can include a single RFID reader with multiple antennas. The first layer 100 can be disposed on top of the second layer 104. It can be appreciated the second layer 104 can be disposed on top of the first layer 100. The mat 103 can be disposed on a support surface of a storage location. For example, the storage location can be a shelving unit, a cabinet, a storage unit or any other storage location and the mat 103 can be placed on a shelf or base of the storage location. While an exemplary embodiment of the present disclosure illustrate a mat 103, in exemplary embodiments, the grid/array of sensors and RFID readers or associated antennas can be integrally formed with a support surface of the storage location (e.g., integrally formed with a shelf).

Physical objects 108 can be disposed on top of the mat 103. An RFID tags 110 encoded with identifiers associated with the physical objects can be disposed on the physical objects 108. The grid of RFID readers or associated antennas 102 can detect the RFID tags 110 disposed on the physical objects 108. Each of the RFID readers in the gird of RFID readers 102 can detect RFID tags within a specified distance of the RFID reader. The RFID readers can decode the identifier from the RFID tag and can determine a signal strength of the transmission from the RFID tag in response to being read based on a proximity of the RFID tag to the RFID readers or associated antennas. For example, an RFID reader in the grid of RFID readers 102 can detect a stronger signal strength emitted by an RFID tag disposed on a physical object which is disposed closer to the RFID reader or an antenna associated with the RFID reader. Alternatively, the RFID reader can detect a weaker signal strength emitted by a RFID tag disposed on a physical object which is disposed farther away from the RFID reader or an antenna associated with the RFID reader.

The grid of weight sensors 106 can be configured to detect weight of the physical object 108 disposed on top of the mat. The grid of weight sensors 106 can include multiple different weight sensors. Each of the weight sensors can detect weight in response to receiving pressure on the mat 103. For example, one or more weight sensors disposed at a certain location on the mat 103 can detect a weight of a physical object 108 disposed at the certain location on the mat 103.

In some embodiments, one or more image capturing devices 112 can be disposed with respect to the mat 103. For example, the image capturing device(s) 112 can be disposed over the mat 103. The image capturing device(s) 112 can be configured to capture images of the physical objects 108 disposed on the mat 103. The image capturing device(s) 112 can capture images after a specified period of time and/or in response to detected motion. The image capturing device 112 can capture still or moving images.

A controller 114 can be coupled to the grid of RFID readers 102, the gird of weight sensors 106 and the image capturing device(s) 112. The RFID readers on the gird of RFID readers 102 can transmit identifiers decoded from the detected the RFID tags 110 disposed on the physical objects 108 to the controller 114. The RFID readers can also transmit the signal strength of the transmissions from the detected RFID tags 110 to the controller 114. The controller 114 can receive the same identifier transmitted by different RFID readers detected at different signal strengths. The controller 114 can determine the location of the RFID tag from which the identifier was decoded, by determining the location of the RFID reader which detected the RFID tag at the highest signal strength or by estimating distances from each of the RIFD readers or associated antennas to the reader RFID tag based on the signal strengths of the transmission received by the RFID readers from the RFID tag.

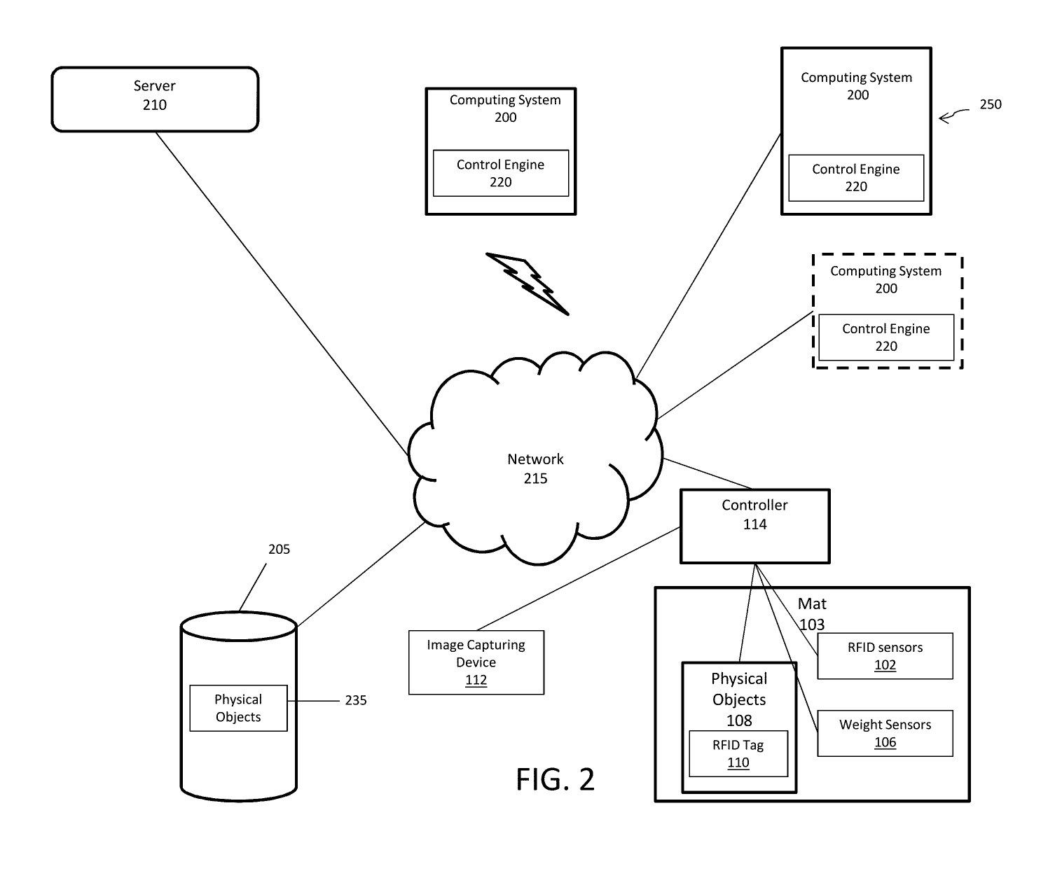

The weight sensors of the gird of weight sensors 106 can transmit the detected weight of the physical objects disposed on the mat 103 to the controller 114. The controller 114 can ascertain the locations on the mat 103 at which the weight sensors detected the weights of the physical objects 108. The controller 114 can map the locations of the RFID tags 110 to the locations of the detected weights, at which the physical objects 108 are disposed. The weights can be associated with corresponding identifiers of the physical objects based on the determined locations of the detected weights on the mat 103 and the locations of the RFID tags disposed on the physical objects. For example, the controller 114 can assign a detected weight of a physical object to a corresponding identifier of the physical object based on matching the location of the weight of the physical object to a determined location of the RFID tag disposed on the physical object. The controller 114 can transmit a message including the identifier and the weight of the physical object assigned to the identifier to a computing system. The details of the computing system will be discussed in further detail with respect to FIG. 2.

In some embodiments, the controller 114 can also receive images of the physical object 108 from the image capturing device 112. The controller can transmit the images to the computing system.

FIG. 2 illustrates an exemplary object location detection system in accordance with an exemplary embodiment. The object location detection system 250 can include one or more databases 205, one or more servers 210, one or more computing systems 200, one or more controllers 114, one or more image capturing devices 112 and one or more mats 103. The mats 103 can include the grid of RFID readers 102 and the grid of weight sensors 106. An RFID tag 110 can be disposed on each of the physical objects 108 that are placed on the mat 103. In exemplary embodiments, the computing system 200 is in communication with one or more of the databases 205, a server 210, the controllers 114 via a communications network 215 and the controller 114 is in communication with the grid of RFID readers 102, the grid of weight sensors 106, and one or more image capturing devices 112. The computing system 200 can execute one or more instances of a control engine 220. The control engine 220 can be an executable application residing on the computing system 400. The control engine 220 can execute the process of the object location detection system 250 as described herein.

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 200 includes one or more computers or processors configured to communicate with the databases 205 and the controllers 114 via the network 215. The computing system 200 hosts one or more applications configured to interact with one or more components of the object location detection system 250. The databases 205 may store information/data, as described herein. For example, the databases 205 can include a physical objects database 235. The physical objects database 235 can store information associated with physical objects. The databases 205 and server 210 can be located at one or more geographically distributed locations from each other or from the computing system 200. Alternatively, the databases 205 can be included within server 210 or computing system 200.

In one embodiment, physical objects 108 can be disposed on top of a mat 102 including a first layer and a second layer. The first layer can include the grid of RFID sensors or associated antennas 102 and the second layer can include the grid of weight sensors 106. The mat 103 can be disposed on a support surface of a storage area associated with a user. An RFID tag 110 encoded with an identifier associated with the physical object can be disposed on each of the physical objects 108. The grid of RFID readers or associated antennas 102 can detect the RFID tags disposed on the physical objects. Each of the RFID readers in the grid of RFID readers 102 can detect RFID tags 110 within a specified distance of the RFID reader. The RFID readers can decode the identifier from the RFID tags 110. The RFID readers can also detect a signal strength of the RFID tag based on proximity of the RFID tags 110 to the RFID readers or associated antennas. For example, an RFID reader in the grid of RFID readers 102 can detect a stronger signal strength emitted by a RFID tags 110 disposed on a physical object 108 which is disposed closer to the RFID reader or associated antenna. Alternatively, the RFID reader can detect a weaker signal strength emitted by a RFID tags 110 disposed on a physical object 108 which is disposed farther away from the RFID readers or associated antennas 102.

The grid of weight sensors 106 can be configured to detect weight of the physical objects 108 disposed on top of the mat 103. The gird of weight sensors 106 can include multiple different weight sensors. Each of the weight sensors can detect weight in response to receiving pressure/force on the mat 103. For example, one or more weight sensors disposed at a certain location on the mat 103 can detect a weight of a physical object 108 disposed at the certain location on the mat 103.

In some embodiments, the image capturing device 112 can be disposed with respect to the mat 103. For example, the image capturing device 112 can be disposed over the mat 103. The image capturing device 112 can be configured to capture images of the physical object 108 disposed on the mat 103. The image capturing device 112 can capture images after a specified period of time. The image capturing device 112 can capture still or moving images.

The controller 114 can be coupled to the grid of RFID readers 102, the gird of weight sensors 106 and the image capturing device 112. The RFID readers on the gird of RFID readers 102 can transmit the identifier decoded from the detected the RFID tag 110 disposed on the physical object 108 to the controller 114. The RFID readers can also transmit the signal strength of the detected RFID tag 110 to the controller 114. The controller 114 can determine the location of the RFID tag 110 from which the identifier was decoded, by determining the location of the RFID reader which detected the RFID tag 110 at the highest signal strength or based on triangulation using the signal strengths to estimate a distance of the physical object from each of the RFID readers or associated antennas to the RFID tag disposed on the physical object that is read by the RFID readers.

The weight sensors of the gird of weight sensors 106 can transmit the detected weight of the physical objects 108 disposed on the mat 103 to the controller 114. The controller 114 can ascertain the location on the mat 103 at which the weight sensors detected the weight of the physical objects 108. The controller 114 can also determine a location of the RFID tag 110, disposed on the physical objects 108, on the mat 103, based on the signal strength detected by the RFID readers. The controller 114 can map the location of the RFID tag 110 to the location of the detected weight, at which the physical objects 108 is disposed. The weight can be associated with the identifier of the physical objects based on the determined location detected weight on the mat 103 and the location of the RFID tags 110 disposed on the physical objects 108. The controller 114 can assign the detected weight to the identifier of the physical objects based on matching the location of a weight of a physical object to determined location of the RFID tags 110 disposed on the physical objects 108. The controller 114 can transmit a message including the identifier, and the weight of the physical objects assigned to the identifiers to the computing system 200. In some embodiments, the controller 114 can transmit the message in response to determining the a change in weight greater than a specified amount.

In some embodiments, the image capturing device 112 can capture images of the physical objects 108 disposed on the mat 103. The image capturing device 112 can transmit the captured images to the controller 114. The controller 114 transmit the images in the message to the computing system 200.

The computing system 200 can receive the messages from the controller 114 and can execute the control engine 220 in response to receiving the message. The control engine 200 can query the physical objects database 235 using the identifier to retrieve information associated with the physical object. The information can include a name of the physical object, a type of physical object, one or more dimensions of the physical object, a weight the physical object when completely full, an average amount of the physical object used at one time, an amount of time required to replenish the physical object, an amount of time the physical object has been associated with the grid of sensors or the RFID readers. The control engine 220 can compare the weight assigned to the identifier and the weight of the physical object when the physical object is at a full volume to determine a quantity of physical object remaining in the storage area. The control engine 220 can determine a rate of consumption of the physical object by the user using the current determined weight of the physical object and the retrieved information. The rate of consumption can be represented by amount of physical object consumed over a period of time. The control engine 220 can trigger an action based on the determined rate of consumption. The action can be to transmit an alert and/or to autonomously transmit a request for more of the physical object to be delivered to the user. For example, the control engine 220 can determine the physical object is decreasing at a rate in which the user will require more of the physical object and can transmit an alert to the user regarding the quantity of the physical object and/or automatically transmit a request for more of the physical object to be delivered to user.

In some embodiments, the messages from the controller to the computing system can include images of the physical objects 108. The control engine 220 can use image analysis and/or machine vision to extract attributes associated with the physical objects from the images. The control engine 220 can determine amount remaining for each of the physical objects captured in the images based on the attributes, an object location for each of the physical objects captured in the images, or an identity for each of the physical objects captured in the image based on the extracted attributes. The control engine 220 can determine the rate of consumption based on determined amount remaining for each of the physical objects captured in the images based on the attributes, an object location for each of the physical objects captured in the images, or an identity for each of the physical objects captured in the image based on the extracted attributes.

In some embodiments, a user can remove a physical object from a first location on top of the mat 103. Weight sensors associated with the first location can output a first change in weight and the RFID readers can fail to read the RFID tag associated with the physical object. The controller 114 can receive the output from the weight sensors and an indication that the RFID tag cannot be read, and can determine that the physical object has been removed from the mat 103. The physical object can be placed at the first location again or at a second location on top of the mat 103. The weight sensors at the first or second locations can output a second change in weight that is equal to or less than the first change in weight, and the controller 114 can determine that the physical object was returned to the first location or the second location on the mat 103. A difference between the first and second change in weight is transmitted to the computing system 200 to be stored in a physical objects database 235. The difference indicates an amount of the physical object that was used after being removed from the first location on the mat and being placed on the second location of the mat 103. The difference can be associated with the user in the physical objects database 235. The accounts database 240 can also include a time stamp of when the physical object was placed at the second location.

A first RFID reader from the physical objects can be disposed within a specified distance of the first location, and a second RFID reader can be disposed within a specified distance of the second location. The first RFID reader can detect a greater signal strength of the RFID tag disposed on the physical object than the second RFID reader when the physical object is disposed at the first location. The second RFID reader can detect a greater signal strength of the RFID tag disposed on the physical object when the physical object is moved to the second location. The controller 114 can receive the signal strength detected by both the first and second RFID readers when the physical object is at the first and second locations. The controller 114 can transmit the detected signal strengths to the computing system 200 and the control engine 220 can determine the physical object has been moved from the first location to the second location on top of mat 103 based on a strength of signal detected by the second RFID reader from a first one of the RFID tags disposed on the first physical object.

In some embodiments, the grid of RFID readers 102 can fail to read the RFID tags disposed on a physical object, when the user removes the physical object from the first location from on top of the mat. The controller 114 can determine that the physical object has been removed from the mat based on a first change in weight and the failure to read the first one of the RFID tags.

As a non-limiting example, the object location detection system 250 can be implemented in a pantry. Products can be disposed in the pantry of a user. The mat 103 can be disposed in the pantry and can be configured to receive the products on a top of the mat 103. RFID tags 110 encoded with identifiers associated with the products can be disposed on the products. The pantry can include consumable edible products such as salt. The salt container containing the salt, can include an RFID tag 110 encoded with an identifier associated with the salt. The grid of RFID readers 102 in the mat 103 can detect the RFID tags disposed on the products (e.g., the RFID tag disposed on the salt).

The RFID readers on the gird of RFID readers 102 can transmit an identifier decoded from the detected the RFID tag 110 disposed on a product (i.e. the salt container) to the controller 114. The controller 114 can map the location of the RFID tag 110 to the location of the detected weight, at which the salt container is disposed. The weight can be associated with the identifier of the salt container based on the determined location detected weight on the mat 103 and the location of the RFID tags 110 disposed on the salt container. The controller 114 can assign the detected weight to the identifier of the salt container based on matching the location of a weight of a product to determined location of the RFID tags 110 disposed on the salt container. The controller 114 can transmit a message including the identifier, and the weight of the products assigned to the identifier to the computing system 200.

In some embodiments, the image capturing device 112 can capture images of the salt container disposed on the mat 103. The image capturing device 112 can transmit the captured images to the controller 114. The controller 114 transmit the images in the message to the computing system 200.

The computing system 200 can receive the message from the controller 114. The control engine can query the products database 235 using the identifier to retrieve information associated with the salt container. The control engine 220 can determine a rate of consumption of the salt by the customer using the current determined weight of the salt container and the retrieved information. The control engine 220 can trigger an action based on the determined rate of consumption. The action can be to transmit an alert and/or to transmit a request for more of the product to be delivered to the customer. For example, the control engine 220 can determine the salt is decreasing at a rate in which the customer will require more of the salt. The control engine 220 can transmit an alert to the customer regarding the quantity of the salt and/or automatically transmit a request for more of the salt to be delivered to customer. The salt can be delivered from a retail store within the vicinity of the customer. In some embodiments, the control engine 220 can determine the product will decompose or become damaged based on the rate of consumption. For example, the product can be a carton of milk, and based on the rate of consumption the customer will not finish the milk before the expiration date. The control engine 220 can transmit an alert to the user. The alert can include the product name, expiration date and date of expected completion of the product.

In some embodiments, a user can remove a salt container and a pepper container from their respective locations in the pantry, use the salt container, and place the salt container back in a second location of the pantry. The user may not put the pepper container back in the pantry. The weight sensors at the second locations can output a change in weight that is equal to or less than a previously detected changes in weights (e.g., from the removal of the salt and pepper), and the controller 114 can determine that the salt container was returned to the mat 103 based on the changes in weight and/or reading of the RFID tag disposed on the salt. The RFID readers can detect the RFID tag disposed on the salt container in response to the weight sensors detecting the change in weight. The RFID readers can transmit the detected identifier to the controller 114. The controller 114 can determine the salt container has been returned to the mat 103, and that the pepper container has not yet been returned to the mat 103.

A first RFID reader can be disposed within a specified distance of the first location, and a second RFID reader can be disposed within a specified distance of the second location. The first RFID reader can detect a greater signal strength of the RFID tag disposed on the salt container than the second RFID reader when the salt container is disposed at the first location. The second RFID reader can detect a greater signal strength of the RFID tag disposed on the salt container when the salt container is moved to the second location. The controller 114 can receive the signal strength detected by both the first and second RFID readers when the physical object is at the first and second locations. The controller 114 can transmit the detected signal strengths to the computing system 200 and the control engine 220 can determine the salt container has been moved from the first location to the second location on top of mat 103 based on a strength of signal detected by the second RFID reader from a first one of the RFID tags disposed on the first physical object.

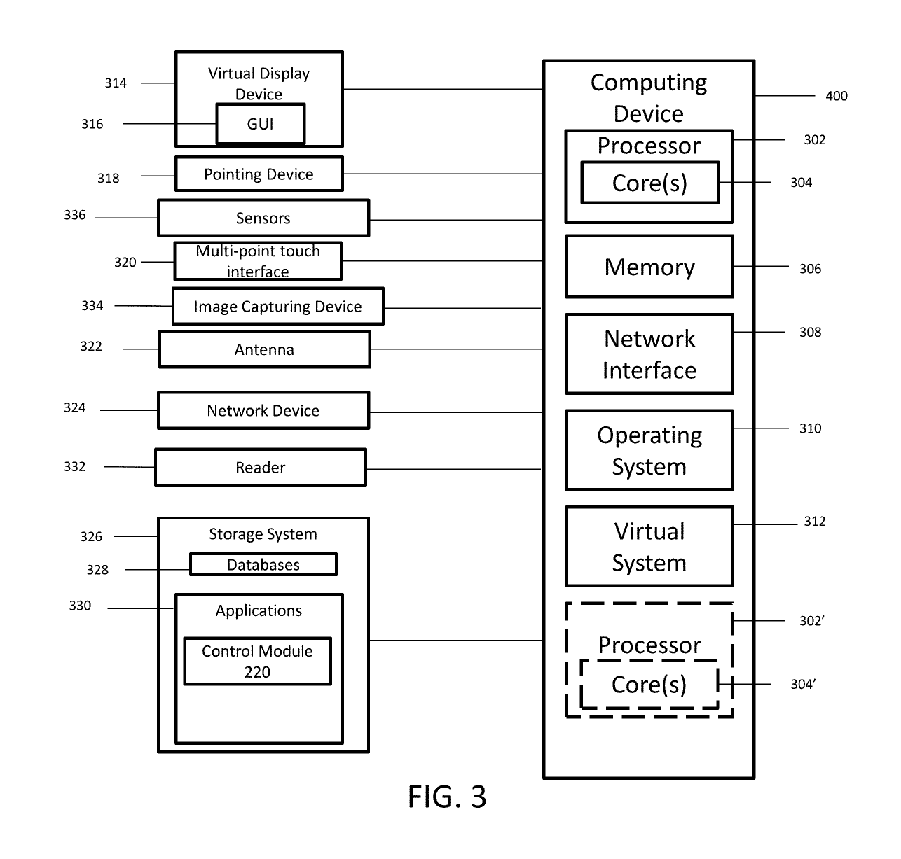

FIG. 3 is a block diagram of an exemplary computing device suitable for implementing embodiments of the automated shelf sensing system. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (304 and 304′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof. The computing device 300 can receive data from input/output devices such as, a reader 332, an image capturing device 334 and weight sensors 336.

A user may interact with the computing device 300 through a visual display device 314, such as a computer monitor, which may display one or more graphical user interfaces 316, multi touch interface 320 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications such as the control engine 220). For example, exemplary storage device 326 can include one or more databases 328 for storing information regarding the physical objects. The databases 328 may be updated manually or automatically at any suitable time to add, delete, and/or update one or more data items in the databases.

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

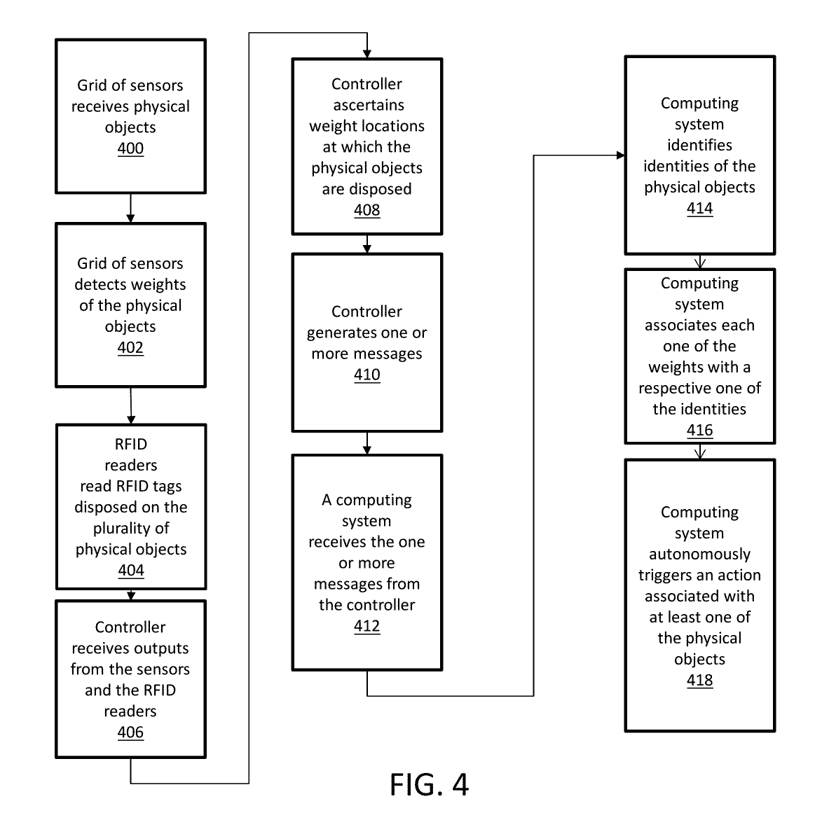

FIG. 4 is a flowchart illustrating an exemplary process performed by the object location system according to an exemplary embodiment. In operation 400, a grid of sensors (e.g. grid of weight sensors 106 as shown in FIG. 1-2) can receive physical objects (e.g. physical object 108 as shown in FIGS. 1-2) on a support surface (e.g. mat 103 as shown in FIGS. 1-2). In operation 402, the grid of sensors can detect weights of the physical objects. In operation 404, RFID readers (e.g. grid of RFID readers 102 as shown in FIGS. 1-2) can read RFID tags (e.g. RFID tags 110 as shown in FIGS. 1-2) disposed on the physical objects to discover identifiers associated with the physical objects. In operation 406, a controller (e.g. controller 114 as shown in FIGS. 1-2) can receive outputs from the sensors and the RFID readers. In operation 408, the controller can ascertain weight locations at which the physical objects are disposed based on the which of the sensor detected the weights. In operation 410, the controller can generate one or more messages that includes the weight locations at which the physical objects are disposed, the weights of physical objects at the weight locations, and the identifiers associated with the physical objects. In operation 412, a computing system (e.g. computing system 200 as shown in FIG. 2) can receive the one or more messages from the controller. In operation 414, the computing system can identify identities of the physical objects based on the identifiers. In operation 416 the computing system can associate each one of the weights with a respective one of the identities based on the weight locations at which the physical objects are disposed. In operation 418, the computing system can autonomously trigger an action associated with at least one of the physical objects.

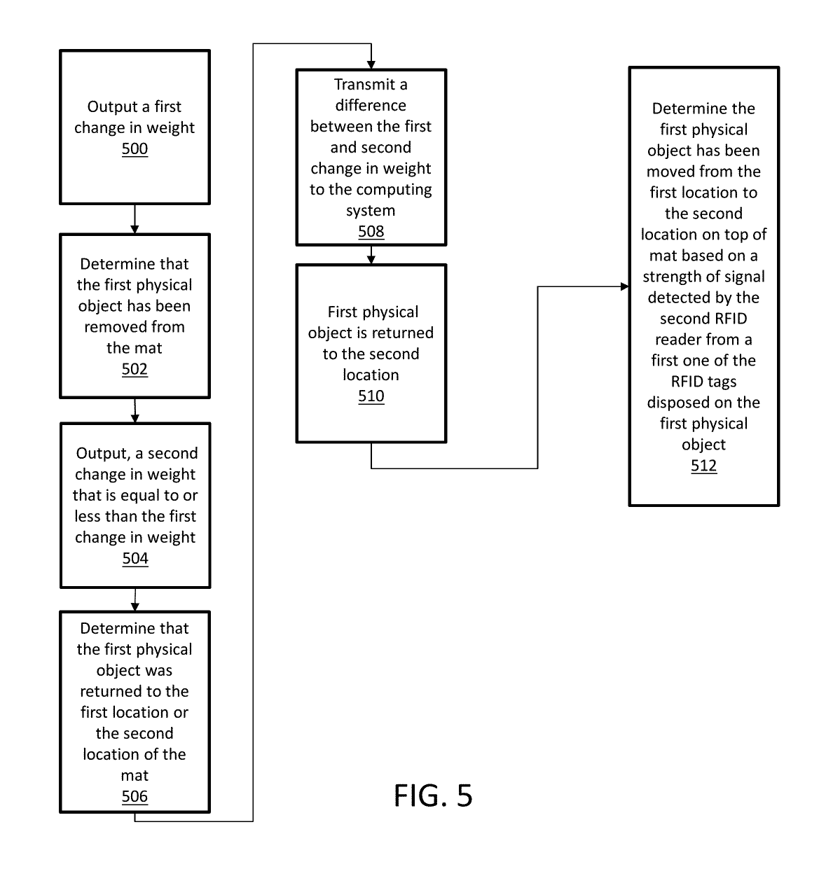

FIG. 5 is a flowchart illustrating an exemplary process performed by the object location system according to an exemplary embodiment. In operation 500, in response to a first physical object (e.g. physical object 108 as shown in FIGS. 1-2) being removed from a first location on top of a mat (e.g. mat 103 as shown in FIGS. 1-2) the grid of weight sensors (e.g. grid of weight sensors 106 as shown in FIG. 1-2) associated with the first location can output a first change in weight. In operation 502, the controller (e.g. controller 114 as shown in FIGS. 1-2) can determine that the first physical object has been removed from the mat. In operation 504, in response to the first physical object being placed at the first location again or at a second location on top of the mat, the weight sensors at the first or second locations of the gird of weight sensors can output, a second change in weight that is equal to or less than the first change in weight. In operation 506, the controller can determine that the first physical object was returned to the first location or the second location of the mat. In operation 508 the controller can transmit a difference between the first and second change in weight to the computing system (e.g. computing system 200 as shown in FIG. 2) to be stored in a database (e.g. physical objects database 235 as shown in FIG. 2). The difference indicates an amount of the first physical object that was used after being removed from the first location on the mat and being placed on the second location of the mat. In operation 510 the first physical object is returned to the second location, a first RFID reader from the plurality of RFID readers is disposed within a specified distance of the first location, and a second RFID reader from the plurality of RFID readers is disposed within a specified distance of the second location. In operation 512, the computing system can determine the first physical object has been moved from the first location to the second location on top of mat based on a strength of signal detected by the second RFID reader from a first one of the RFID tags disposed on the first physical object.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An object detection system based on object weight and radio frequency signals, the system comprising:
a grid of sensors configured to be disposed on a support surface for receiving a plurality of physical objects and to detect weights of the physical objects;
a plurality of RFID readers disposed in proximity to the grid of sensors, the plurality of RFID readers configured to read RFID tags disposed on the plurality of physical objects to discover identifiers associated with the physical objects;
a controller operatively coupled to the gird of sensors and plurality of RFID readers, the controller being configured to receive outputs from the sensors and the plurality of RFID readers, ascertain weight locations at which the physical objects are disposed based on the which of the sensor detected the weights, and generate one or more messages that includes the weight locations at which the physical objects are disposed, the weights of physical objects at the weight locations, and the identifiers associated with the physical objects; and
a computing system programmed to:
receive the one or more messages from the controller;
identify identities of the physical objects based on the identifiers;
associate each one of the weights with a respective one of the identities based on the weight locations at which the physical objects are disposed; and
autonomously trigger an action associated with at least one of the physical objects.

2. The system of claim 1, wherein the RFID readers measure signal power from each of the RFID tags read by the plurality of the RFID readers, and the controller is configured to:
determine RFID locations at which the RFID tags are disposed based on the signal power; and
map the RFID locations at which the RFID tags are disposed to the weight locations at which the physical objects are disposed.

3. The system of claim 2, wherein each one of the weights is associated with the respective one of the identities based on the weight locations at which the physical objects are disposed and the RFID locations at which the RFID tags are disposed, and the controller is configured to:
assign each one of the weights to the respective one of identities of the physical objects based on matching the weight locations to the RFID locations.

4. The system of claim 1, wherein the computing system includes a database and is programmed to:
query the database to retrieve information associated with the at least one physical object;
determine a rate of consumption of the at least one of the physical objects based on the retrieved information and a current weight of the at least one of the physical objects.

5. The system of claim 4, wherein the information is one or more of: a weight of the at least one of the physical objects when completely full, an average amount of the at least one of the physical objects used at one time, an amount of time required to replenish the at least one of the physical objects, an amount of time the at least one of the physical objects has been associated with the grid of sensors or the RFID readers.

6. The system of claim 1, further comprising an image capturing device disposed with respect to the plurality physical objects and operatively coupled to the computing system, the image capturing device being configured to capture images of the plurality of physical objects and transmit the captured images to the controller in response to detecting motion of one or more of the physical objects or in response to a period of time elapsing since a last image capture.

7. The system of claim 6, wherein the computing system is further programmed to:
receive the images from the controller;
extract a plurality of attributes associated with each physical objects captured in the images; and
determine at least one of an amount remaining for each of the physical objects captured in the images based on the plurality of attributes, an object location for each of the physical objects captured in the images, or an identity for each of the physical objects captured in the images.

8. The system of claim 1, wherein the grid of sensors is disposed across a first layer of a mat, and the plurality of RFID readers are disposed across a second layer of the mat.

9. The system of claim 8, wherein the plurality of physical objects are supported by the mat.

10. The system of claim 8, wherein, in response to a first physical object from the plurality of physical objects being removed from a first location on top of the mat, the sensors associated with the first location output a first change in weight, and the controller determines that the first object has been removed from the mat,
wherein, in response to the first physical object being placed at the first location again or at a second location on top of the mat, the sensors at the first or second locations output a second change in weight that is equal to or less than the first change in weight, and the controller determines that the first physical object was returned to the first location or the second location, and
wherein a difference between the first and second change in weight is transmitted to the computing system to be stored in a database, the difference indicating an amount of the first physical object that was used after being removed from the first location on the mat and being placed on the second location of the mat.

11. The system of claim 10, wherein the first physical object is returned to the second location, a first RFID reader from the plurality of RFID readers is disposed within a specified distance of the first location, and a second RFID reader from the plurality of RFID readers is disposed within a specified distance of the second location, and
wherein the computing system is further programmed to determine the first physical object has been moved from the first location to the second location on top of mat based on a strength of signal detected by the second RFID reader from a first one of the RFID tags disposed on the first physical object.

12. The system of claim 8, wherein, in response to a first physical object from the plurality of physical objects being removed from a first location on top of the mat, the sensors associated with the first location output a first change in weight, the plurality of RFID readers fail to read a first one of the RFID tags affixed to the first physical object, and the controller determines that the first object has been removed from the mat based on the first change in weight and the failure to read the first one of the RFID tags, and
wherein, in response to the first physical object being placed at the first location again or at a second location on top of the mat, the sensors at the first or second locations output a second change in weight that is equal to or less than the first change in weight, at least some of the RFID readers read the first one of the RFID tags, and the controller determines that the first physical object was returned to the first location or the second location based on the second change in weight and reading of the first one of the RFID tags again.

13. The system of claim 12, wherein the controller determines that the first one of the physical objects is replaced at the second location, and the controller transmits a new message to the computing system indicating that the first physical object has been moved to the second location, and the computing system updates a map of physical object locations based on the new message.

14. An object detection method based on object weight and radio frequency signals, the method comprising:
receiving, via a grid of sensors disposed on a support surface, a plurality of physical objects;
detecting, via the grid of sensors, weights of the physical objects;
reading, via a plurality of RFID readers disposed in proximity to the grid of sensors, RFID tags disposed on the plurality of physical objects to discover identifiers associated with the physical objects;
receiving, via a controller, outputs from the sensors and the plurality of RFID readers;
ascertaining, via the controller, weight locations at which the physical objects are disposed based on the which of the sensor detected the weights;
generating, via the controller, one or more messages that includes the weight locations at which the physical objects are disposed, the weights of physical objects at the weight locations, and the identifiers associated with the physical objects;
receiving, via a computing system, the one or more messages from the controller;
identifying, via the computing system, identities of the physical objects based on the identifiers;
associating, via the computing system, each one of the weights with a respective one of the identities based on the weight locations at which the physical objects are disposed; and
autonomously triggering, via the computing system, an action associated with at least one of the physical objects.

15. The method of claim 14, further comprising:
measuring, via the plurality of RFID readers, signal power from each of the RFID tags;
determining, via the controller, RFID locations at which the RFID tags are disposed based on the signal power; and
mapping, via the controller, the RFID locations at which the RFID tags are disposed to the weight locations at which the physical objects are disposed.

16. The method of claim 14, further comprising:
querying, via the computing system, a database included on the computing system to retrieve information associated with the at least one physical object;
determining, via the computing system, a rate of consumption of the at least one of the physical objects based on the retrieved information and a current weight of the at least one of the physical objects.

17. The method of claim 14, further comprising:
capturing, via an image capturing device disposed with respect to the plurality physical objects and operatively coupled to the computing system, images of the plurality of physical objects;
transmitting, via the image capturing device, the captured images to the controller in response to detecting motion of one or more of the physical objects or in response to a period of time elapsing since a last image capture;
receiving, via the computing system, the images from the controller;
extracting, via the computing system, a plurality of attributes associated with each physical objects captured in the images; and
determining, via the computing system, at least one of an amount remaining for each of the physical objects captured in the images based on the plurality of attributes, an object location for each of the physical objects captured in the images, or an identity for each of the physical objects captured in the images.

18. The method of claim 14, wherein the grid of sensors is disposed across a first layer of a mat, and the plurality of RFID readers are disposed across a second layer of the mat and the plurality of physical objects are supported by the mat.

19. The method of claim 18, further comprising:
in response to a first physical object from the plurality of physical objects being removed from a first location on top of the mat, outputting, via the sensors associated with the first location, a first change in weight;
determining, via the controller, that the first object has been removed from the mat,
in response to the first physical object being placed at the first location again or at a second location on top of the mat, outputting, via the sensors at the first or second locations, a second change in weight that is equal to or less than the first change in weight;
determining, via the controller, that the first physical object was returned to the first location or the second location, and
transmitting, via the controller, a difference between the first and second change in weight to the computing system to be stored in a database, the difference indicating an amount of the first physical object that was used after being removed from the first location on the mat and being placed on the second location of the mat.

20. The method of claim 19, wherein the first physical object is returned to the second location, a first RFID reader from the plurality of RFID readers is disposed within a specified distance of the first location, and a second RFID reader from the plurality of RFID readers is disposed within a specified distance of the second location.

21. The method of claim 20, further comprising:
determining, via the computing system, the first physical object has been moved from the first location to the second location on top of mat based on a strength of signal detected by the second RFID reader from a first one of the RFID tags disposed on the first physical object.

22. The method of claim 18, further comprising:
in response to a first physical object from the plurality of physical objects being removed from a first location on top of the mat, outputting via the sensors associated with the first location, a first change in weight, the plurality of RFID readers fail to read a first one of the RFID tags affixed to the first physical object;
determining, via the controller, that the first object has been removed from the mat based on the first change in weight and the failure to read the first one of the RFID tags, and
in response to the first physical object being placed at the first location again or at a second location on top of the mat, outputting, via the sensors at the first or second locations, a second change in weight that is equal to or less than the first change in weight, at least some of the RFID readers read the first one of the RFID tags;
determining, via the controller, that the first physical object was returned to the first location or the second location based on the second change in weight and reading of the first one of the RFID tags again;
determining, via the controller, that the first one of the physical objects is replaced at the second location; and
transmitting, via the controller, a new message to the computing system indicating that the first physical object has been moved to the second location, and the computing system updates a map of physical object locations based on the new message.
